(19) United States
(12) Patent Application Publication
(10) Pub. No.: US 2026/0338623 A1
(43) Pub. Date: Oct. 29, 2026

(54) STRAIN GAGE UNDERCUT FOR SIGNAL AMPLIFICATION

(71) Applicants: CNPC USA CORPORATION, Houston, TX (US); BEIJING HUAMEI INC., Beijing (CN); CHINA NATIONAL PETROLEUM CORPORATION, Beijing (CN)

(72) Inventors: Joseph MUNGUIA, Houston, TX (US); Wade EVANS, II, Katy, TX (US)

(21) Appl. No.: 19/186,960

(22) Filed: Apr. 23, 2025

(51) Int. Cl. G01L 1/22; B23B 49/00

(52) U.S. Cl. CPC G01L 1/2287; B23B 49/00

(57) ABSTRACT

Systems for measuring a load of a drilling bit under a downhole condition and methods for measuring the same are disclosed. A system for measuring a load of a drilling bit under a downhole condition may comprise a cylindrical drill string component, a recess area, and at least one sensor. The cylindrical drill string component may have a cylindrical outer surface including one or more drill string component grooves recessed into a cylindrical outer surface of the cylindrical drill string component; a recess area between two grooves; and at least one sensor configured to be located on an outer surface of the recessed area. The at least one sensor is configured to obtain measurements indicative of one or more forces applied to the drill bit during a drilling operation. The at least one sensor is a strain gage.

### FIELD

Embodiments of this disclosure relate generally to systems and methods for drilling into the Earth, and to systems and methods for measuring a load of a drilling bit under a downhole condition.

### BACKGROUND

A borehole is drilled through a geological formation deep in the earth to discover and produce hydrocarbons, such as oil and gas. A borehole can be formed by a drill string comprised of a drill bit connected to sections of long pipe or drill pipe. The drill string extends from the surface to the bottom of the borehole. The drill bit is rotated so that the drill string advances through the geological formation, thereby forming the borehole. The drill bit can be rotated by rotating the drill string from the surface in rotary drilling. Steering the drill bit requires data of the downhole conditions so that position, orientation, and velocity of the drill bit can be determined. Then, the position, orientation, and velocity of the drill bit can be altered to drill the desired path of borehole through the geological formation. Collected data is used to generate estimates and projections for the drill bit to navigate through and around the geological formations. Weight on Bit (WOB), Mud Pump Pressure, Rate of Penetration (ROP), Gravity Toolface (GTF), Inclination (INC) and Azimuth (AZI) and other traditional oil field measurements, like depth, temperature and pressure, are used to determine Projection to Bit (PTB), True Vertical Depth (TVD) and other estimates of the borehole. The PTB is particularly relevant for the position and orientation of the borehole end when the drill bit is at the bottom of the borehole. The PTB and other projections, not actual measurements at the bottom of the hole.

Estimating a downhole condition is not as accurate as actually measuring the downhole condition. The directly measured data can be used to increase the accuracy of the previous projected borehole conditions. Actual data, instead of estimates calculated from large distances away, make the determination of borehole conditions more accurate.

The excessive movement and vibrations at the bottom of the borehole usually hinder the durability and accuracy of sensors at this location. Sensor placement on a drill bit is also remote and requires a reliable local power source that cannot be regularly accessed for recharging.

These measurement components and/or sensors can include, for example, gyroscopes, magnetometers and accelerometers, strain gages, which can provide position, directional information, borehole inclination, borehole azimuth and information about the drill bit. This information may then be transmitted to the surface through, for example, pulses in the mud column (frequently referred to as a mud pulse), wireless electronic communications (for example, electromagnetic telemetry) and wired communications.

Some implementations include connecting measurement components and/or sensors to an insert that is placed inside the hollow interior of a drill collar using a circular cutout of the drill collar and a plug to protect the electrical components, or using individual plates to cover one or more pockets that are cut into the outer surface of a drill collar and seal each individual component.

However, it was realized by the inventors of the current disclosure that problems exist with current systems for using downhole measurement components and/or sensors that are connected to the drill string during drilling and that improvements in measuring a load of a drill bit by a strain gage in the harsh environment of the drill string during operation are needed. More specifically, poor accuracy of the strain gage measurement in downhole environment. Certain preferred features of the present disclosure address these and other needs and provide other important advantages.

### SUMMARY

Embodiments of the present disclosure provide improved apparatuses and methods for protecting drill string components.

In accordance with aspects of embodiments of the present disclosure, force-sensing apparatuses for measuring a load of a drilling bit under a downhole condition is disclosed. The apparatuses may comprise a drill string component and at least one sensor. The drill string component may define a cylindrical outer surface. The cylindrical outer surface may include one or more drill string component grooves recessed into the cylindrical outer surface of the drill string component. A recess area may have a smaller outer diameter than that of the cylindrical outer surface of the drill string component. At least one sensor may be configured to be located on an outer surface of the recessed area, at least one sensor configured to obtain measurements indicative of one or more forces applied to the drill bit during a drilling operation.

Optionally in any embodiment, at least one sensor is a strain gage.

Optionally in any embodiment, the recessed area has flat surfaces on the outer surface of the recessed area.

Optionally in any embodiment, the strain gages are situated on flat surfaces designated as strain pads around the outer surface of the recessed area.

Optionally in any embodiment, there is at least one strain gage are for axial gages, at least one torque gage.

Optionally in any embodiment, the four axial strain gages are about 90 degrees apart around the outer surface of the recessed area and at least two axial strain gages are parallel to each other.

Optionally in any embodiment, the two torque strain gages are about 180 degrees apart around the outer surface of the recessed area and parallel to each other.

Optionally in any embodiment, at least one of the flat surfaces situate on a plane that is parallel to a central axis of the drill string component.

In accordance with further aspects of embodiments of the present disclosure, methods of measuring a load of a drilling bit under a downhole condition are disclosed. The methods can include: assembling a cylindrical drill string component having a cylindrical outer surface including one or more drill string component grooves recessed into a cylindrical outer surface of the cylindrical drill string component; and inserting at least one sensor configured to be located on an outer surface of the recessed area, at least one sensor configured to obtain measurements indicative of one or more forces applied to the drill bit during a drilling operation. At least one sensor is a strain gage.

Optionally in any embodiment, a recess area having a smaller outer diameter than that of the cylindrical outer surface of the drill string component.

Optionally in any embodiment, the recessed area has flat surfaces on the outer surface of the recessed area.

Optionally in any embodiment, the strain gages are situated on flat surfaces designated as strain pads around the outer surface of the recessed area.

Optionally in any embodiment, the four axial strain gages are about 90 degrees apart around the outer surface of the recessed area and at least two axial strain gages are parallel to each other.

Optionally in any embodiment, the two torque strain gages are about 180 degrees apart around the outer surface of the recessed area and parallel to each other.

Optionally in any embodiment, at least one of the flat surfaces situate on a plane that is parallel to a central axis of the drill string component.

Further in another embodiment, a system for measuring a load of a drilling bit under a downhole condition may comprise a cylindrical drill string component, a recess area, and at least one sensor. The cylindrical drill string component may have a cylindrical outer surface including one or more drill string component grooves recessed into a cylindrical outer surface of the cylindrical drill string component; a recess area between two grooves; and at least one sensor configured to be located on an outer surface of the recessed area. At least one sensor is configured to obtain measurements indicative of one or more forces applied to the drill bit during a drilling operation, wherein at least one sensor is a strain gage.

Optionally in any embodiment, the recessed area has flat surfaces on the outer surface of the recessed area.

Optionally in any embodiment, at least one axial strain gage is about 90 degrees apart to two axial strain gages and at least two axial strain gages are parallel to each other.

Optionally in any embodiment, at least one of the flat surfaces situate on a plane that is parallel to a central axis of the drill string component.

This summary is provided to introduce a selection of the concepts that are described in further detail in the detailed description and drawings contained herein. This summary is not intended to identify any primary or essential features of the claimed subject matter. Some or all of the described features may be present in the corresponding independent or dependent claims, but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various apparatuses and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

Some of the figures shown herein may include dimensions or may have been created from scaled drawings. However, such dimensions, or the relative scaling within a figure, are by way of example, and not to be construed as limiting.

FIG. 1 is a side view of a system for measuring a load of a drilling bit according to at least one embodiment of the present disclosure.

FIG. 2 is a side view of the system for measuring a load of a drilling bit depicted in FIG. 1 with the outer cover depicted as transparent.

FIG. 3 is a cross-sectional view of a recessed area showing strain gages according to one exemplary embodiment;

FIG. 4 is a front view of positive Y axis initial orientation at 0 degree rotation according to one embodiment;

FIG. 5 is a resistance equation formula.

### DETAILED DESCRIPTION OF THE ILLUSTRATED EMBODIMENTS

For the purposes of promoting an understanding of the principles of the disclosure, reference will now be made to one or more embodiments, which may or may not be illustrated in the drawings, and specific language will be used to describe the same. It will nevertheless be understood that no limitation of the scope of the disclosure is thereby intended; any alterations and further modifications of the described or illustrated embodiments, and any further applications of the principles of the disclosure as illustrated herein are contemplated as would normally occur to one skilled in the art to which the disclosure relates. At least one embodiment of the disclosure is shown in great detail, although it will be apparent to those skilled in the relevant art that some features or some combinations of features may not be shown for the sake of clarity.

Any reference to “invention” that may occur within this document is a reference to an embodiment of a family of inventions, with no single embodiment including features that are necessarily included in all embodiments, unless otherwise stated. Furthermore, although there may be references to benefits or advantages provided by some embodiments, other embodiments may not include those same benefits or advantages, or may include different benefits or advantages. Any benefits or advantages described herein are not to be construed as limiting to any of the claims.

Likewise, there may be discussion with regards to “objects” associated with some embodiments of the present invention, it is understood that yet other embodiments may not be associated with those same objects, or may include yet different objects. Any advantages, objects, or similar words used herein are not to be construed as limiting to any of the claims. The usage of words indicating preference, such as “preferably,” refers to features and aspects that are present in at least one embodiment, but which are optional for some embodiments.

Specific quantities (spatial dimensions, temperatures, pressures, times, force, resistance, current, voltage, concentrations, wavelengths, frequencies, heat transfer coefficients, dimensionless parameters, etc.) may be used explicitly or implicitly herein, such specific quantities are presented as examples only and are approximate values unless otherwise indicated. Discussions pertaining to specific compositions of matter, if present, are presented as examples only and do not limit the applicability of other compositions of matter, especially other compositions of matter with similar properties, unless otherwise indicated.

Embodiments of the present disclosure provide a system for measuring a load of a drill bit under a downhole condition.

Embodiments include systems and methods that allow measurement components (for example, electronics, such as at least one sensors) to be directly mounted to a component of the drill string. For example, in some embodiments, the at least one sensors are mounted to a drill collar, which is typically a heavy cylindrical component of the drill string that is located near the drill bit to provide weight and stability to the drill bit. These at least one sensors may be a part of a measurement measurement component or perform some other functions, such as sensing characteristics of the drill string, a drill bit and/or the surrounding environment. In some embodiments, electronic components that are connected to the drill pipe are sealed with a protective sleeve that creates a protected cavity for the electronics and shields the electronics from harmful drilling conditions.

Embodiments of the present disclosure provide a method of measuring a load of a drill bit by using at least one sensor connected to portions of a drill string, and some embodiments provide a protective assembly that is easy to assemble and maintain.

Embodiments of the present disclosure seal off one or more electronics cavities.

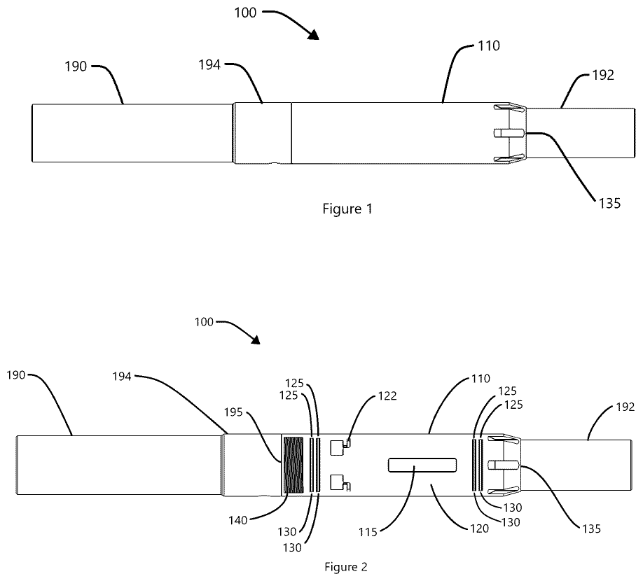

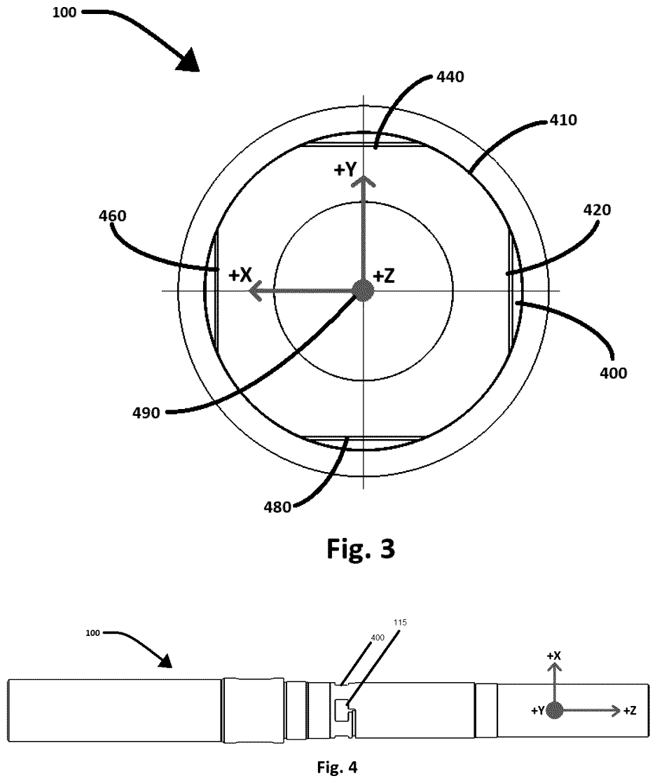

FIGS. 1-2 depict a system 100 for measuring a load of a drilling bit under a downhole condition according to one or more embodiments of the present disclosure. System 100 may include an outer cover (for example, a sleeve 110) that surrounds a portion of the drill string 190. In the example shown in FIGS. 1-2, a sleeve 110 is used as an example outer cover and a drill collar 192 is used as an exemplary portion of the drill string. System 100 further includes one or more grooves 120 (which may be referred to as pockets), which are included in outer surface of the portion of the drill string 190 surrounded by the sleeve 110 (in the illustrated example, in the outer surface of the drill collar 192) and/or are included in the inner surface of the outer cover. A recess area 400 (shown in FIG. 4) may have a smaller outer diameter than that of the cylindrical outer surface of the drill string component.

The outer cover (sleeve 110) may be a single-piece member of unitary construction (such as a solid piece of metal that is milled to form the hollow cylinder or a single-piece hollow cylinder formed through additive manufacturing), or in some embodiments may be a multi-piece member (for example, two semi-circular halves of a hollow cylinder that engage and longitudinally slide against one another and engage and form a single hollow cylinder). Although depicted as having a circular outer surface, additional embodiments of sleeve 110 have outer surfaces of different shapes, such cylindrical geometric shapes (for example, pentagons, hexagons and octagons).

Pockets 120 form one or more locations where measurement components (for example, electronic components, such as at least one sensor 115) may be located. At least one sensor 115, for example, that are positioned within the one or more pockets 120 may be recessed below the adjacent surface of the component where the pockets are located (for example, drill collar 192). In some embodiments, at least one sensor 115 may be configured to obtain measurements indicative of one or more forces applied to the drill bit during a drilling operation, for example. At least one sensor 115 may be a strain gage. Optional channels 122 forming differently sized (for example, smaller) recesses in the outer surface of the exemplary drill collar 192 may be included to provide locations where measurement components (or components of measurement) of different sizes (for example, electrical connectors between the larger electronic components) may be received.

An optional feature of the one or more pockets 120 and/or the one or more channels 122 is that they may be configured to snugly receive the measurement components being positioned therein. Advantages of these embodiments include reducing movement of the measurement components within the one or more pockets 120 and/or the one or more channels 122 (for example, reduce rattling) while the drill string 190 is in use. In some embodiments the snug fit of the one or more measurement components into the one or more pockets 120 and/or channels may include a friction fit, an interference fit, or a click fit (for example, one or more of the side surfaces of the pockets 120 and/or channels 122 may be chamfered. Although some embodiment use a press fit, care should be used since the forces required for a press fit can damage sensitive measurement components (such as electronic components 115) and/or the drill collar 192.

Some embodiments include complimentary threaded surfaces on the sleeve 110 and the drill collar 192 to maintain the connection between the sleeve 110 and the drill collar 192. For example, FIG. 2 depicts threads 140 on the left side of the illustrated sleeve 110 and drill collar 192 that engage with one another and facilitate a firm connection between the sleeve 110 and the drill collar 192. When connecting the sleeve 110 to the drill collar 192, the sleeve 110 may be slipped over a portion of the drill collar 192 (slipped over the right side of the drill collar 192 in FIG. 2) and moved along the drill collar 192 until the threads begin to engage. The sleeve 110 may then be rotated to engage the threads. The sleeve 110 may also include receptacles (for example, the measurement component receptacles 135 illustrated in FIGS. 1-2) to enhance the ability of a user to provide torque to rotate the sleeve 110 with respect to the drill collar 192. In at least some embodiments, the thread direction is chosen so that friction between the sleeve 110 and the exterior earth and/or drilling mud further tightens the sleeve 110 onto the drill collar 192 and thereby inhibits loosening of the sleeve 110 during use.

In some embodiments, sealing members enhance the sealing of electronic components 115 from the environment outside the system 100. In some embodiments the threads 140 are the sealing members and sufficiently seal the electronic components 115 from the outside environment. However, other embodiments include sealing members in addition to the threads 140 to seal the electronic components 115 from the outside environment. For example, some embodiments include O-rings 125 as sealing members. Additional pockets 130 to accommodate the one or more O-rings 125 may also be included in the drill collar 192 and/or the sleeve 110 to assist with positioning the one or more O-rings 125.

Embodiments of system 100 may also include features that assist with proper positioning of sleeve 110 on drill collar 192. For example, an abutment surface 195 may be included to stop the rotation of sleeve 110 in the appropriate location during installation of sleeve 110 on drill collar 192. In some embodiments, the abutment surface 195 is integrated with the drill collar 192 (drill string component), while in other embodiments the abutment surface may be part of a separate member, such as a connected drill string subassembly 194. Receptacles (for example, measurement component receptacles) may also be included on the component that includes the abutment surface 195 to facilitate applying torque to connection between sleeve 110 and drill collar 192 and creating a secure connection between the sleeve 110 and the drill collar 192.

In use, at least one sensor 115 (measurement components) are placed into the pockets 120 and/or channels 122 where at least one sensor 115 may be snugly embraced by the pockets 120 (and optionally the channels 122). One end of the drill collar 192 (drill string component) is inserted into the sleeve 110. In FIGS. 1 and 2, the right end of the drill collar 192 is inserted into the left end of the sleeve 110. The sleeve 110 is then slid over the drill collar 192 until the threads 140 on the sleeve 110 and the drill collar 192 contact one another. The sleeve 110 and the drill collar 192 are then rotated with respect to one another to engage the threads 140.

One or more optional O-rings 125 positioned between the sleeve 110 and the drill collar 192, such as by be being positioned in one or more O-ring pockets 130 in the drill collar 192, will engage the sleeve 110. Additional torque may need to be applied once the one or more O-rings 125 are pinched between the sleeve 110 and the drill collar 192. At any time during installation, additional torque can be applied using the receptacles (torque enhancing features), such as by engaging the measurement component receptacles (for example, tool receptacles 135) with torqueing tools.

When the end of the sleeve 110 adjacent the threads 140 contacts the abutment surface 195, additional torque may be applied to the sleeve 110 and the drill collar 192 to create a firm connection between the sleeve 110 and the drill collar 192. Again, one or more torqueing tools engaging the one or more measurement component receptacles 135 may be used to add the additional torque. During drilling, forces exerted onto the sleeve 110 by the external environment are in a direction that will further tighten the sleeve 110 onto the drill collar 192.

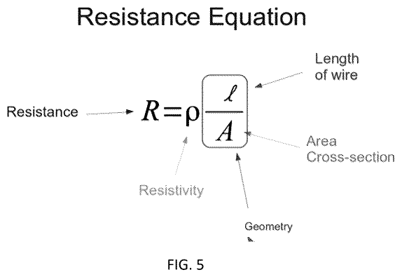

As shown in FIGS. 4, 5, the recessed area 400 may have flat surfaces, such as 420, 440, 460, and 480, on the outer surface 410 of the recessed area 400. The strain gages are situated on flat surfaces 420, 440, 460, and 480 designated as strain pads around the outer surface 410 of the recessed area. 400. More specifically, at least four strain gages are for axial gages, at least two strain gages are for torque gages. Even more specifically, axial gage and torque gage may be situated on the flat surface 440. Axial gage and torque gage may be situated on the flat surface 480. Axial gage W1 may be situated on the flat surface 460. Axial gage W4 may be situated on the flat surface 420. In one embodiment, at least one axial strain gage such as W1 may be about 90 degrees apart to two axial strain gages. At least two axial strain gagesare parallel to each other.

In one embodiment, at least one of the flat surfaces 420, 440, 460, and 480 may situate on a plane that is parallel to a central axis 490 of the drill string component 100.

A strain gage is a device used to measure strain on an object. Invented by Edward E. Simmons and Arthur C. Ruge in 1938, the most common type of strain gauge consists of an insulating flexible backing which supports a metallic foil pattern. The gauge is attached to the object by a suitable adhesive, such as cyanoacrylate. As the object is deformed, the foil is deformed, causing its electrical resistance to change. This resistance change, usually measured using a Wheatstone bridge, is related to the strain by the quantity known as the gauge factor.

As a wire stretches, its cross-section decreases, which causes an increase in resistance. The strain gage operates under this principle. The resistance equation is shown as FIG. 5 below.

Limber cross section of gage pad will allow for more strain at the strain gage because it will reduce geometry disruptions near strain gage by removing fixture alignment holes for more relaxed strain gage field and allow more strain readings at the gage.

Reference systems that may be used herein can refer generally to various directions (e.g., upper, lower, forward and rearward), which are merely offered to assist the reader in understanding the various embodiments of the disclosure and are not to be interpreted as limiting.

To clarify the use of and to hereby provide notice to the public, the phrases “at least one of A, B, . . . and N” or “at least one of A, B, . . . . N, or combinations thereof” or “A, B, . . . and/or N” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. As one example, “A, B and/or C” indicates that all of the following are contemplated: “A alone,” “B alone,” “C alone,” “A and B together,” “A and C together,” “B and C together,” and “A, B and C together.” If the order of the items matters, then the term “and/or” combines items that can be taken separately or together in any order. For example, “A, B and/or C” indicates that all of the following are contemplated: “A alone,” “B alone,” “C alone,” “A and B together,” “B and A together,” “A and C together,” “C and A together,” “B and C together,” “C and B together,” “A, B and C together,” “A, C and B together,” “B, A and C together,” “B, C and A together,” “C, A and B together,” and “C, B and A together.”

While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used or applied in combination with some or all of the features of other embodiments unless otherwise indicated. One or more exemplary embodiments have been shown and described, and all changes and modifications that come within the spirit of the disclosure are desired to be protected.

### ELEMENT NUMBERING

Table 1 includes element numbers and at least one word used to describe the element and/or feature represented by the element number. However, none of the embodiments disclosed herein are limited to these descriptions. Other words may be used in the description or claims to describe a similar member and/or feature, and these element numbers can be described by other words that would be understood by a person of ordinary skill reading and reviewing this disclosure in its entirety.

TABLE 1

| | |
|---|---|
| 100 | drill string component protection system |
| 110 | Sleeve |
| 115 | measurement component (electronic components) |
| 120 | Pocket |
| 122 | Channels |
| 125 | O-rings |
| 130 | o-ring Grooves |
| 135 | receptacles |
| 140 | Threads |
| 190 | drill string |
| 192 | drill collar |
| 194 | Subassembly |
| 195 | abutment surface |

What is claimed is:

1. A force-sensing apparatus for measuring a load of a drilling bit under a downhole condition, comprising:
a drill string component defining a cylindrical outer surface, the cylindrical outer surface including one or more drill string component grooves recessed into the cylindrical outer surface of the drill string component, a recess area having a smaller outer diameter than that of the cylindrical outer surface of the drill string component; and
at least one sensor configured to be located on an outer surface of the recessed area, the at least one sensor configured to obtain measurements indicative of one or more forces applied to the drill bit during a drilling operation.

2. The force-sensing apparatus of claim 1, wherein the at least one sensor is a strain gage.

3. The force-sensing apparatus of claim 2, wherein the recessed area has flat surfaces on the outer surface of the recessed area.

4. The force-sensing apparatus of claim 3, wherein the strain gages are situated on flat surfaces designated as strain pads around the outer surface of the recessed area.

5. The force-sensing apparatus of claim 2, wherein at least four strain gages are for axial gages, at least two strain gages are for torque gages.

6. The force-sensing apparatus of claim 5, wherein at least one axial strain gage is about 90 degrees apart to two axial strain gages and at least two axial strain gages are parallel to each other.

7. The force-sensing apparatus of claim 5, wherein the two torque strain gages are about 180 degrees apart around the outer surface of the recessed area and parallel to each other.

8. The force-sensing apparatus of claim 4, wherein at least one of the flat surfaces situate on a plane that is parallel to a central axis of the drill string component.

9. A method for measuring a load of a drill bit under a downhole condition, comprising:
assembling a cylindrical drill string component having a cylindrical outer surface including one or more drill string component grooves recessed into a cylindrical outer surface of the cylindrical drill string component; and
inserting at least one sensor configured to be located on an outer surface of the recessed area, the at least one sensor configured to obtain measurements indicative of one or more forces applied to the drill bit during a drilling operation, wherein the at least one sensor is a strain gage.

10. The method of claim 9, wherein a recess area having a smaller outer diameter than that of the cylindrical outer surface of the drill string component.

11. The method of claim 9, wherein the recessed area has flat surfaces on the outer surface of the recessed area.

12. The method of claim 11, wherein the strain gages are situated on flat surfaces designated as strain pads around the outer surface of the recessed area.

13. The method of claim 12, wherein at least four strain gages are for axial gages, at least two strain gages are for torque gages.

14. The method of claim 13, wherein at least one axial strain gage is about 90 degrees apart to two axial strain gages and at least two axial strain gages are parallel to each other.

15. The method of claim 13, wherein the two torque strain gages are about 180 degrees apart around the outer surface of the recessed area and parallel to each other.

16. The method of claim 12, wherein at least one of the flat surfaces situate on a plane that is parallel to a central axis of the drill string component.

17. A system for measuring a load of a drill bit under a downhole condition, comprising:
a cylindrical drill string component having a cylindrical outer surface including one or more drill string component grooves recessed into a cylindrical outer surface of the cylindrical drill string component; and
at least one sensor configured to be located on an outer surface of the recessed area, the at least one sensor configured to obtain measurements indicative of one or more forces applied to the drill bit during a drilling operation, wherein the at least one sensor is a strain gage.

18. The system of claim 17, wherein the recessed area has flat surfaces on the outer surface of the recessed area.

19. The system of claim 17, wherein at least four strain gages are for axial gages, at least two strain gages are for torque gages, wherein at least one axial strain gage is about 90 degrees apart to two axial strain gages and at least two axial strain gages are parallel to each other.

20. The system of claim 17, wherein at least one of the flat surfaces situate on a plane that is parallel to a central axis of the drill string component.
